(19) United States
(12) Patent Application Publication
(10) Pub. No.: US 2017/0141806 A1
(43) Pub. Date: May 18, 2017

(54) METHOD AND APPARATUS FOR IDENTIFICATION OF A MOBILE DEVICE PERIPHERAL

(71) Applicant: BlackBerry Limited, Waterloo (CA)

(72) Inventors: Lawrence Edward KUHL, Waterloo (CA); Nazih ALMALKI, Waterloo (CA)

(21) Appl. No.: 14/939,472

(22) Filed: Nov. 12, 2015

(51) Int. Cl. H04B 1/3888; H04M 1/725

(52) U.S. Cl. CPC H04B 1/3888; H04M 1/72575

(57) ABSTRACT

A method at a mobile device for recognizing and adapting to a peripheral device, the method obtaining a reading from a magnetic sensor on the mobile device associated with a magnet on the peripheral device; determining, from the reading, at least one of a polarity or a magnetic field strength of the magnet; identifying a type of the peripheral device based on the at least one of the polarity or magnetic field strength of the magnet; and adapting the mobile device to the type of the peripheral device.

### FIELD OF THE DISCLOSURE

The present disclosure relates to peripherals for mobile devices and in one aspect relates to covers including flip covers for mobile devices.

### BACKGROUND

Mobile devices may have various accessories, including cases or holders. Such items are designed to attach to, support or otherwise hold the mobile device. Examples of cases include flip type cases in which a cover may be folded over the screen of the mobile device when the device is not in use, sleeves, supports or other similar covers.

In some cases it may be useful for a mobile device to know the type of accessory associated with the device. For example, a type of flip cover may have a window at a particular location. In this case, the device may need to know the type of the flip cover in order to utilize the window properly.

In order to configure a device for use with a particular accessory, currently either the accessory type needs to be manually input into the mobile device, or in some cases electronics may be provided within the accessory to communicate with the device. Such electronics increase the cost of the cover and require specialized connections such as near field communications or an actual physical electrical connection to the cover of the device. Configuring the accessory within a menu on the mobile device is cumbersome and leads to a poor user experience.

### BRIEF DESCRIPTION OF THE DRAWINGS

The present disclosure will be better understood with reference to the drawings, in which:

FIG. 1 is a top plan view of a mobile device having a first flip case;

FIG. 2 is a top plan view of a mobile device having a second flip case with a single window in an open position;

FIG. 3 is a top plan view of the mobile device and flip case of FIG. 2 with the flip cover closed;

FIG. 4 is a top plan view of a mobile device having a third flip case with two windows in an open position;

FIG. 5 is a top plan view of the mobile device and flip case of FIG. 4 with the flip cover closed;

FIG. 6 is a top plan view of a mobile device having a fourth flip case with a single window and two magnets in an open position;

FIG. 7 is a top plan view of the mobile device and flip case of FIG. 6 with the flip cover closed;

FIG. 8 is a top plan view of a mobile device and a first sleeve cover;

FIG. 9 is a top plan view of the mobile device and first sleeve cover of FIG. 8 in which the mobile device has been inserted into the first sleeve cover;

FIG. 10 is a top plan view of a mobile device a second sleeve cover having a single window;

FIG. 11 is a top plan view of the mobile device and second sleeve cover of FIG. 10 in which the mobile device has been inserted into the second sleeve cover;

FIG. 12 is a block diagram showing a process to identify a peripheral at a mobile device and to modify the behavior of the mobile device; and

FIG. 13 is a block diagram of an example mobile device that can be used with the present disclosure.

### DETAILED DESCRIPTION OF THE DRAWINGS

The present disclosure provides a method at a mobile device for recognizing and adapting to a peripheral device, the method comprising: obtaining a reading from a magnetic sensor on the mobile device associated with a magnet on the peripheral device; determining, from the reading, at least one of a polarity or a magnetic field strength of the magnet; identifying a type of the peripheral device based on the at least one of the polarity or magnetic field strength of the magnet; and adapting the mobile device to the type of the peripheral device.

The present disclosure further provides a mobile device configured for recognizing and adapting to a peripheral device, the mobile comprising: a processor; a user interface; and a magnetic sensor, wherein the mobile device is configured to: obtain a reading from a magnetic sensor on the mobile device associated with a magnet on the peripheral device; determine, from the reading, at least one of a polarity or a magnetic field strength of the magnet; identify a type of the peripheral device based on the at least one of the polarity or magnetic field strength of the magnet; and adapt the mobile device to the type of the peripheral device.

The present disclosure further provides a non-transitory computer readable medium for storing instructions which when executed by a processor at a mobile device enable recognizing and adapting the mobile device to a peripheral device, the instructions comprising code for: obtaining a reading from a magnetic sensor on the mobile device associated with a magnet on the peripheral device; determining, from the reading, at least one of a polarity or a magnetic field strength of the magnet; identifying a type of the peripheral device based on the at least one of the polarity or magnetic field strength of the magnet; and adapting the mobile device to the type of the peripheral device.

The present disclosure is described below with regard to flip covers and sleeve covers for mobile devices. However, the present disclosure could be used with other types of accessories, including other device holders, chargers, docking stations, among others. The present disclosure is thus not limited to covers and the description of covers is utilized only for illustration purposes.

The present disclosure relates to techniques for identifying customized peripherals for a mobile device utilizing a magnetic field generated within the peripheral. In one example, a variety of covers with physical magnets may comprise the peripheral. The covers may come in a variety of types and the behavior of the device may be customized to suit the type of cover being used. In order to allow for this functionality, the device must identify the type of cover being used.

In accordance with one embodiment of the present disclosure, a magnetometer such as a Hall Effect sensor may be utilized within the mobile device to measure a magnetic field strength of a magnet within the mobile device peripheral. The polarity and/or the magnetic field strength may then be utilized to identify the peripheral from an enumerated list of peripherals for the device.

For example, a Hall Effect sensor capable of distinguishing between four magnetic field strengths and magnetic field polarities may be used to identify eight peripherals, since each of the magnetic field strengths may be recognized both in the positive and negative polarity. In other embodiments two peripherals may be identified based on the positive or negative polarity. In other embodiments, the Hall Effect sensor may be more sensitive and more devices may be identified. In still further embodiments, a plurality of magnets may be utilized with a plurality of Hall Effect sensors to expand the range of peripheral devices that may be identified.

Reference is now made to the Figures. Like numerals are used in the different drawings.

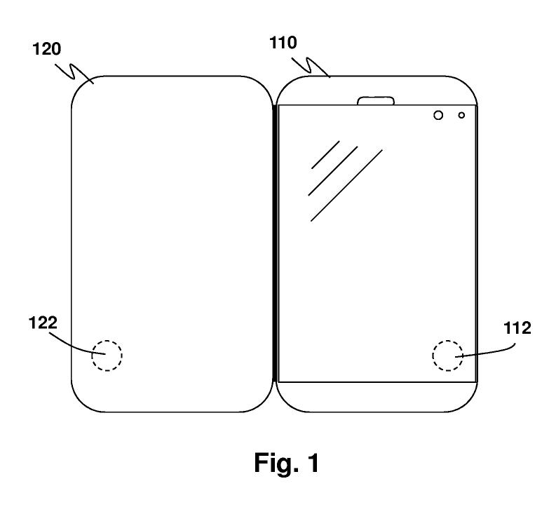

Referring to FIG. 1, a mobile device 110 may be placed within a first flip case 120. In the example of FIG. 1, mobile device 110 includes a magnetic sensor 112, such as a Hall Effect sensor. The flip case 120 includes a magnet 122 placed in a location where the position of the magnet 122 will correspond with the position of the magnetic sensor 112 when the flip case is closed. As described below, the magnetic sensor 112 may then determine the polarity and magnetic field of magnet 122 to determine the type of peripheral that is being utilized. In this case, flip case 120 would be identified by the mobile device.

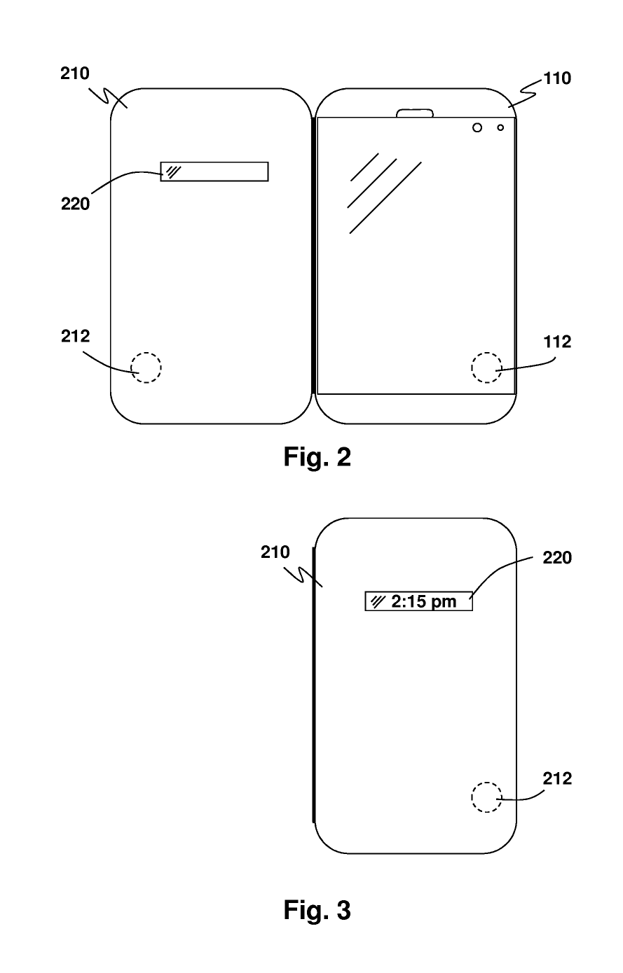

In another example, as shown in FIG. 2, a mobile device 110 includes magnetic sensor 112. In the example of FIG. 2, mobile device 110 is placed within flip case 210. Flip case 210 includes a magnet 212, as well as a window 220. In the example of FIG. 2, window 220 is shown as a transparent layer. In other embodiments, window 220 may be a cut away portion of a cover of flip case 210. Other examples are possible.

FIG. 3 shows the flip case 210 in a closed position over mobile device 110. In this case, magnet 212 aligns with magnetic sensor 112 and mobile device 110 knows that the flip case has particular properties. Specifically, the mobile device 110 knows that window 220 is located at a particular position and has a certain shape and size. In this case, mobile device 110 may exhibit certain behavior such as showing, for example, the time through the window 220 in flip case 210, where the time display is positioned correctly in relation to window 220.

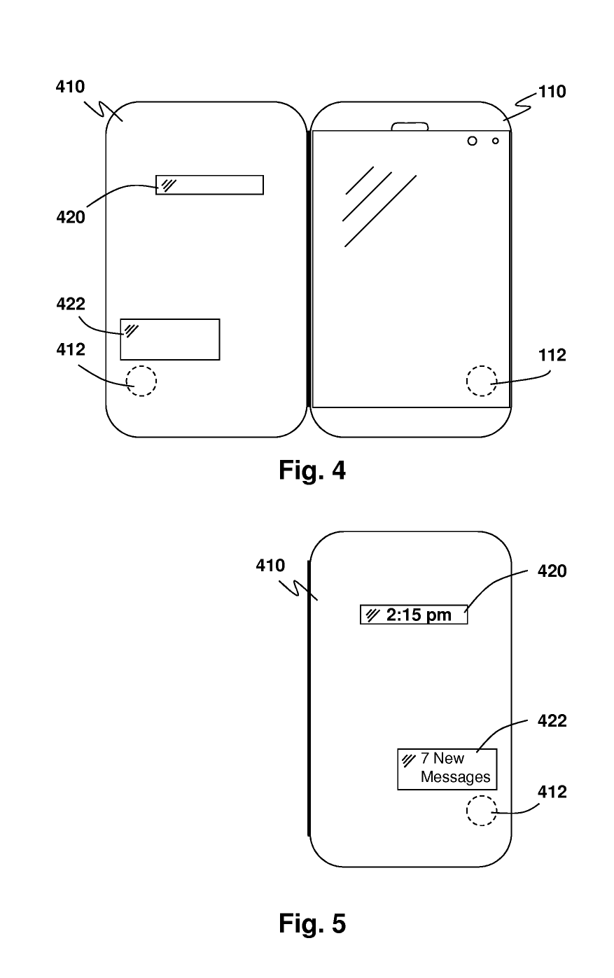

Similarly, reference is now made to FIG. 4 in which mobile device 110 includes a magnetic sensor 112. A flip case 410 is utilized with mobile device 110. Flip case 410 includes a magnet 412 as well as windows 420 and 422.

FIG. 5 shows flip case 410 in a closed position. In this embodiment, magnet 412 is aligned with magnetic sensor 112. Based on readings from magnetic sensor 112 and information stored on the device, mobile device 110 knows that the flip case 410 includes two windows and the location and size and shape of those windows. The mobile device may therefore display, for example, a time in window 420 and a message such as the number of messages waiting in window 422. However, this is merely an example and in other cases the mobile device may provide different information within windows 420 and 422.

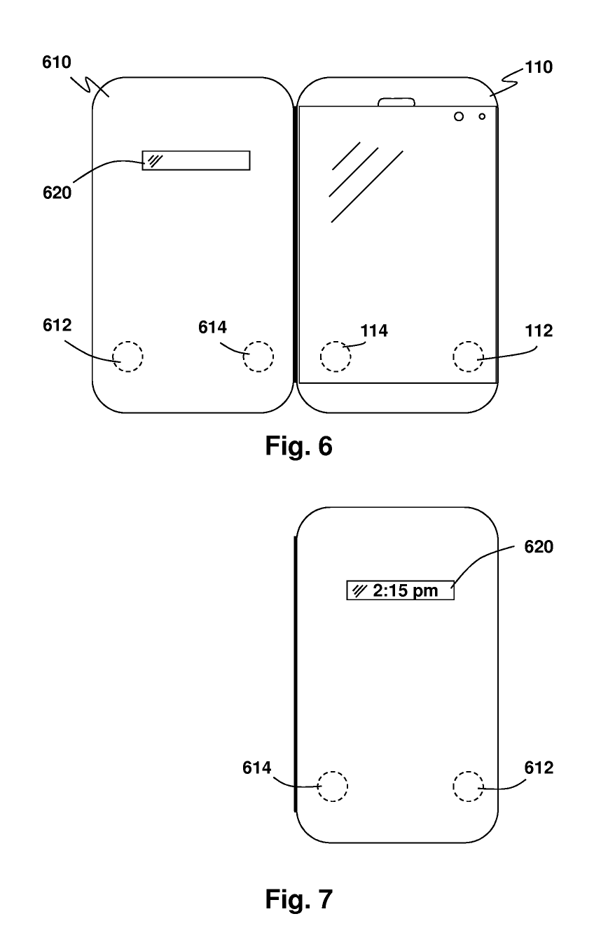

In a further embodiment, instead of having a single magnetic sensor, a device may have a plurality of magnetic sensors. For example, reference is now made to FIG. 6, which shows a mobile device 110 with a first magnetic sensor 112 as well as a second magnetic sensor 114. Similarly, a device may have 3, 4 or more sensors.

In the embodiment of FIG. 6, the device is placed within a case 610 which includes a magnet 612 and a magnet 614. The location of magnets 612 and 614 correspond with the location of sensors 112 and 114 when the flip case is closed.

In the example of FIG. 6, case 610 includes a window 620.

FIG. 7 shows case 610 in a closed position. In this embodiment the mobile device 110 may display information through the window 620.

While the above discusses flip cases and windows, in other embodiments the behavior of the device may be customized for the flip case. In some instances, instead of a window, the case may not cover a portion of the screen and the behavior of the device may be modified for this aspect of the case. Other aspects of the case may also be identified and utilized by the device based on the magnetic strength of the one or more magnets in the case. For example, a particular case may have a button for a camera feature in a particular location corresponding to a button or key on the mobile device. The mobile device behavior may be modified to allow for the pressing of button or key on the device to take a picture. Thus the present disclosure is not limited to particular windows or features of the case, but rather allows for the identification of the peripheral by the mobile device in order to customize the behavior of the mobile device.

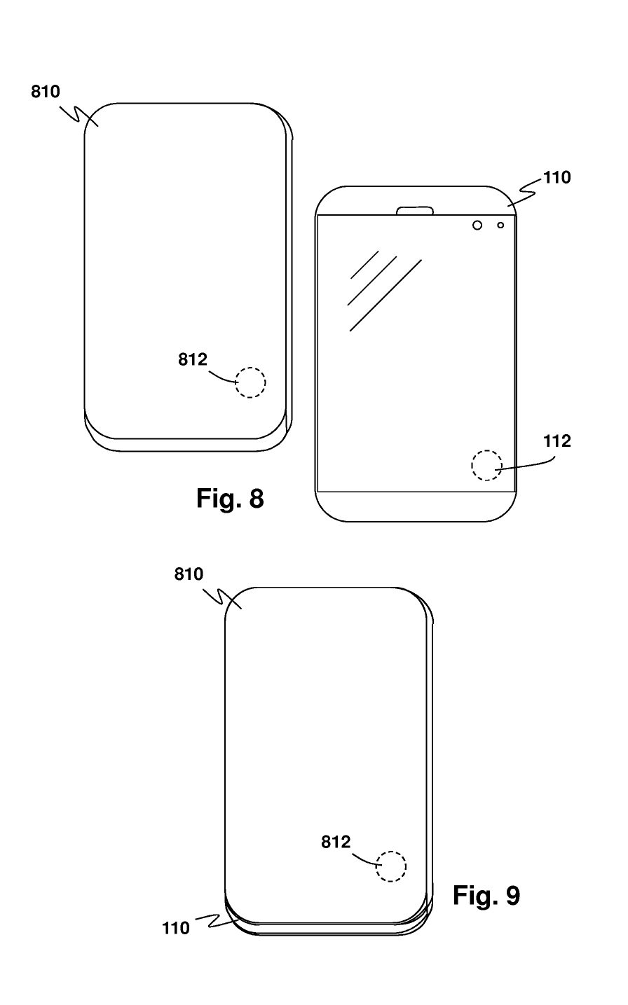

Further, instead of a flip case, the second peripheral may be a sleeve that the device may be placed in to. Reference is now made to FIG. 8. In FIG. 8, a mobile device 110 includes a magnetic sensor 112. The peripheral is a sleeve 810 with a magnet 812.

As seen in FIG. 9, the device 110 may be placed within the sleeve 810 and the magnet 812 aligns with the sensor 112.

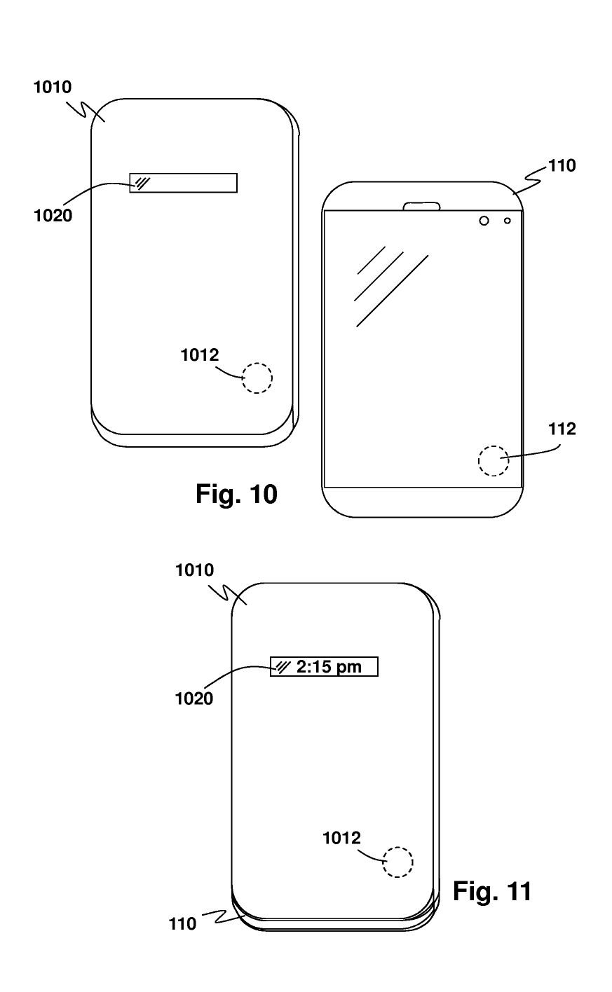

Similar to the flip case, various customization may be provided with regard to the sleeve. For example, in FIG. 10 a device 110 includes the magnetic sensor 112. In this case sleeve 1010 has a magnet 1012. The sleeve further includes a window 1020 in a particular location and having a particular size and shape.

Thus, as seen in FIG. 11, if device 110 is placed within the sleeve 1010, the magnet 1012 aligns with sensor 112 and the device may therefore utilize window 1020 to display information.

As with the embodiments of FIGS. 1 to 7 above, the sleeve may have one or more windows which may be different sizes and shapes and be placed in different locations. For example, in some cases a round window may be utilized. In other cases, square or rectangular windows may be utilized. The identification of the case to the device utilizing one or more magnetic sensors may allow the behavior of the device to be customized for the peripheral.

Further, as with the embodiment of FIGS. 6 and 7 above, the sleeve may have a plurality of magnets and the mobile device 110 may include a plurality of magnet sensors.

Besides flip cases and sleeves, the present disclosure could be used with other types of peripherals. Examples may include bicycle mounts for holding a mobile device, car mounts, running or exercise holders, or other type of cases, charging pads, among others.

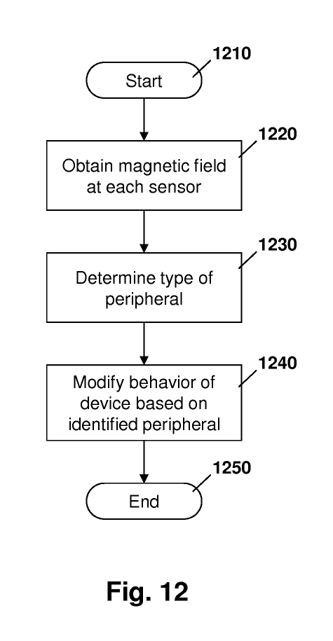

In each of the embodiments, the mobile device identifies the peripheral through the use of the magnetic field and polarity of the magnet. Reference is now made to FIG. 12, which shows a process at a mobile device for modifying the behavior of the device based on the type of peripheral.

In particular, the process of FIG. 12 starts at block 1210 and proceeds to block 1220 in which the device obtains magnetic field information for each of the magnetic field sensors on the mobile device. Thus, if the device has only one sensor, the device may obtain magnetic field information from that sensor. If there are a plurality of magnetic field sensors the mobile device may obtain information from each of the sensors.

The obtaining of the magnetic field readings may be done after a threshold amount of time in which the magnetic field is stable. Thus, for example, when the flip cover is being closed the magnetic field will vary as the cover is being closed. However, once the cover is closed for a threshold time period then the reading may be taken and may be determinative of the type of case that the device is in.

In one example, each magnetic sensor will continuously determine the magnetic field. As the case is closed the magnetic sensor will begin to detect an increasing magnetic field. After the case is closed the magnetic field will stabilize and the magnetic sensor can register a value after a threshold time period.

In one embodiment, the obtaining at block 1220 only obtains the polarity of each magnet. In other embodiments, the obtaining at block 1220 obtains a magnetic field strength but ignores polarity. In still another embodiment the obtaining at block 1220 obtains both a field strength and polarity for each magnet in the case.

Once the magnetic field information, including field strength and/or polarity, is identified at the magnetic field sensor, the process then proceeds to block 1230 in which the type of peripheral is determined. For example, the mobile device may have stored in memory a table indicating field strength and polarity with regard to various peripheral types. Such table may also be determinative of the type of behavior that the device should exhibit based on that peripheral.

Reference is made to Table 1 below, which shows a table for a case having a single magnet in which the magnetic field polarity may be determined, and in which four magnetic field strengths may be distinguished.

TABLE 1
Peripheral and Behavior Identification

| Polarity | Strength | Peripheral | Behavior |
|---|---|---|---|
| + | A | 000 | File1 |
| + | B | 001 | File2 |
| + | C | 010 | File3 |
| + | D | 011 | Fi1e4 |
| − | A | 100 | File5 |
| − | B | 101 | File6 |
| − | C | 110 | File7 |
| − | D | 111 | File8 |

As seen in Table 1 above, the polarity may be positive or negative and the strength may be one of four values. This is merely meant as an example and in other cases fewer or more field strengths could be measured based on the type of sensor used within the mobile device.

In practice, a reading could be made by a magnetic sensor and the reading approximated to one of the enumerated values, such as those shown in Table 1.

In the example of Table 1 above, the peripheral is identified through a identifier such as a binary identifier and a behavior may be associated with each of the types of peripherals. In other cases the peripheral does not need to be specifically identified, but merely the behavior associated with the peripheral needs to be configured.

The behavior, for example, may be a particular file that specifies the type of information and the location of the information that the device should display when the peripheral is being utilized. In other cases the behavior may be enumerated directly in Table 1.

In another example, if two sensors are utilized, each having the ability to distinguish between two field strengths and the two polarities, then 16 peripherals may be identified. Reference is made to Table 2 below.

TABLE 2
Peripheral and Behavior Identification

| Polarity1 | Strength1 | Polarity2 | Strength2 | Peripheral | Behavior |
|---|---|---|---|---|---|
| + | A | + | A | 0000 | File1 |
| + | A | + | B | 0001 | File2 |
| + | A | − | A | 0010 | File3 |
| + | A | − | B | 0011 | File4 |
| + | B | + | A | 0100 | File5 |
| + | B | + | B | 0101 | File6 |
| + | B | − | A | 0110 | File7 |
| + | B | − | B | 0111 | File8 |
| − | A | + | A | 1000 | File9 |
| − | A | + | B | 1001 | File10 |
| − | A | − | A | 1010 | File11 |
| − | A | − | B | 1011 | File12 |
| − | B | + | A | 1100 | File13 |
| − | B | + | B | 1101 | File14 |
| − | B | − | A | 1110 | File15 |
| − | B | − | B | 1111 | File16 |

As seen in Table 2 above, the use of a sensors that can identify only two different field strengths and the polarity therefore leads to 16 combinations, meaning 16 peripherals can be identified.

Thus the number of peripherals identified can be varied based the number of sensors and magnets, and/or the sensitivity of such sensors to the differences in field strength.

Referring again to FIG. 12, once the type of peripheral is identified, the process proceeds to block 1240 in which the behavior of the device is modified based on the identified peripheral. Such device behavior may be modified, for example, through a behavior field such as those identified in Tables 1 and 2 above. In other cases, the behavior may be modified based on a look-up of the peripheral through a network connection. In other cases the behavior may be modified through a look-Up in a secondary table. In any case, knowledge of the type of peripheral can lead to customized behavior.

From block 1240, the process proceeds to block 1250 and ends.

Tables 1 or 2 may be provided to the device during device manufacture. In other instances, the tables may be provisioned to the device, for example over the air or when the device establishes a connection to another computing device, among other options.

The different magnetic field strengths may be provided through the use of different sized magnets within the peripheral, or through the use of different magnetic materials for each peripheral device. Thus, a first peripheral device may use a larger sized magnet than a second peripheral device. The magnetic size may be varied based on the width (e.g. diameter), height or both of the magnet. In other cases different magnetic materials may be utilized within the different peripheral devices.

The orientation of the magnet can be used to change polarity

The magnetic sensor on the device may include a Hall Effect sensor, which are known to those in the art. Such Hall Effect sensors may include the ability to distinguish between the polarities of the magnet. The Hall Effect sensors may further include the ability to distinguish between various magnetic field strengths of the magnet.

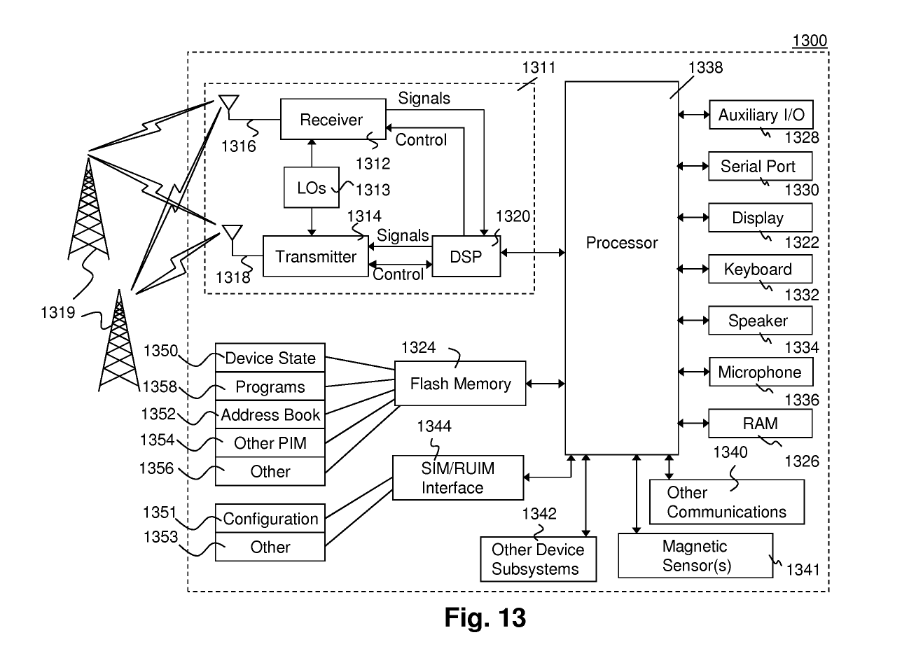

The above may be utilized with any mobile device. One example of a mobile device is provided below with regard to FIG. 13.

Mobile device 1300 may be any user equipment, and in one case may be a two-way wireless communication device having voice and data communication capabilities. Depending on the exact functionality provided, the mobile device may be referred to as a data messaging device, a two-way pager, a wireless e-mail device, a cellular telephone with data messaging capabilities, a wireless Internet appliance, a wireless device, a user equipment, or a data communication device, as examples.

Where mobile device 1300 is enabled for two-way communication, it may incorporate a communication subsystem 1311, including both a receiver 1312 and a transmitter 1314, as well as associated components such as one or more antenna elements 1316 and 1318, local oscillators (LOs) 1313, and a processing module such as a digital signal processor (DSP) 1320. As will be apparent to those skilled in the field of communications, the particular design of the communication subsystem 1311 will be dependent upon the communication network in which the device is intended to operate.

Network access requirements will also vary depending upon the type of network 1319. In some networks network access is associated with a subscriber or user of mobile device 1300. A mobile device may require a removable user identity module (RUIM) or a subscriber identity module (SIM) card in order to operate on a network. The SIM/RUIM interface 1344 is normally similar to a card-slot into which a SIM/RUIM card can be inserted and ejected. The SIM/RUIM card can have memory and hold many key configurations 1351, and other information 1353 such as identification, and subscriber related information.

When required network registration or activation procedures have been completed, mobile device 1300 may send and receive communication signals over the network 1319. As illustrated in FIG. 13, network 1319 can consist of multiple base stations communicating with the mobile device.

Signals received by antenna 1316 through communication network 1319 are input to receiver 1312, which may perform such common receiver functions as signal amplification, frequency down conversion, filtering, channel selection and the like. A/D conversion of a received signal allows more complex communication functions such as demodulation and decoding to be performed in the DSP 1320. In a similar manner, signals to be transmitted are processed, including modulation and encoding for example, by DSP 1320 and input to transmitter 1314 for digital to analog conversion, frequency up conversion, filtering, amplification and transmission over the communication network 1319 via antenna 1318. DSP 1320 not only processes communication signals, but also provides for receiver and transmitter control. For example, the gains applied to communication signals in receiver 1312 and transmitter 1314 may be adaptively controlled through automatic gain control algorithms implemented in DSP 1320.

Mobile device 1300 generally includes a processor 1338 which controls the overall operation of the device. Communication functions, including data and voice communications, are performed through communication subsystem 1311. Processor 1338 also interacts with further device subsystems such as the display 1322, flash memory 1324, random access memory (RAM) 1326, auxiliary input/output (I/O) subsystems 1328, serial port 1330, one or more keyboards or keypads 1332, speaker 1334, microphone 1336, other communication subsystem 1340 such as a short-range communications subsystem and any other device subsystems generally designated as 1342. Serial port 1330 could include a USB port or other port known to those in the art.

Processor 1338 may further interact with one or more magnetic sensors 1341 in accordance with the embodiments described above.

Some of the subsystems shown in FIG. 13 perform communication-related functions, whereas other subsystems may provide “resident” or on-device functions. Notably, some subsystems, such as keyboard 1332 and display 1322, for example, may be used for both communication-related functions, such as entering a text message for transmission over a communication network, and device-resident functions such as a calculator or task list.

Operating system software used by the processor 1338 may be stored in a persistent store such as flash memory 1324, which may instead be a read-only memory (ROM) or similar storage element (not shown). Those skilled in the art will appreciate that the operating system, specific device applications, or parts thereof, may be temporarily loaded into a volatile memory such as RAM 1326. Received communication signals may also be stored in RAM 1326.

As shown, flash memory 1324 can be segregated into different areas for both computer programs 1358 and program data storage 1350, 1352, 1354 and 1356. These different storage types indicate that each program can allocate a portion of flash memory 1324 for their own data storage requirements. Processor 1338, in addition to its operating system functions, may enable execution of software applications on the mobile device. A predetermined set of applications that control basic operations, including at least data and voice communication applications for example, will normally be installed on mobile device 1300 during manufacturing. Other applications could be installed subsequently or dynamically.

Applications and software may be stored on any computer readable storage medium. The computer readable storage medium may be a tangible or in transitory/non-transitory medium such as optical (e.g., CD, DVD, etc.), magnetic (e.g., tape) or other memory known in the art.

One software application may be a personal information manager (PIM) application having the ability to organize and manage data items relating to the user of the mobile device such as, but not limited to, e-mail, calendar events, voice mails, appointments, and task items. Naturally, one or more memory stores would be available on the mobile device to facilitate storage of PIM data items. Such PIM application may have the ability to send and receive data items, via the wireless network 1319. Further applications may also be loaded onto the mobile device 1300 through the network 1319, an auxiliary I/O subsystem 1328, serial port 1330, short-range communications subsystem 1340 or any other suitable subsystem 1342, and installed by a user in the RAM 1326 or a non-volatile store (not shown) for execution by the processor 1338. Such flexibility in application installation increases the functionality of the device and may provide enhanced on-device functions, communication-related functions, or both. For example, secure communication applications may enable electronic commerce functions and other such financial transactions to be performed using the mobile device 1300.

In a data communication mode, a received signal such as a text message or web page download will be processed by the communication subsystem 1311 and input to the processor 1338, which may further process the received signal for output to the display 1322, or alternatively to an auxiliary I/O device 1328.

A user of mobile device 1300 may also compose data items such as email messages for example, using the keyboard 1332, which may be a complete alphanumeric keyboard or telephone-type keypad, among others, in conjunction with the display 1322 and possibly an auxiliary I/O device 1328. Such composed items may then be transmitted over a communication network through the communication subsystem 1311.

For voice communications, overall operation of mobile device 1300 is similar, except that received signals would typically be output to a speaker 1334 and signals for transmission would be generated by a microphone 1336. Alternative voice or audio I/O subsystems, such as a voice message recording subsystem, may also be implemented on mobile device 1300. Although voice or audio signal output is generally accomplished primarily through the speaker 1334, display 1322 may also be used to provide an indication of the identity of a calling party, the duration of a voice call, or other voice call related information for example.

Serial port 1330 in FIG. 13 would normally be implemented in a personal digital assistant (PDA)-type mobile device for which synchronization with a user's desktop computer (not shown) may be desirable, but is an optional device component. Such a port 1330 would enable a user to set preferences through an external device or software application and would extend the capabilities of mobile device 1300 by providing for information or software downloads to mobile device 1300 other than through a wireless communication network. The alternate download path may for example be used to load an encryption key onto the device through a direct and thus reliable and trusted connection to thereby enable secure device communication. As will be appreciated by those skilled in the art, serial port 1330 can further be used to connect the mobile device to a computer to act as a modem.

Other communications subsystems 1340, such as a short-range communications subsystem, is a further optional component which may provide for communication between mobile device 1300 and different systems or devices, which need not necessarily be similar devices. For example, the subsystem 1340 may include an infrared device and associated circuits and components or a Bluetooth™ communication module to provide for communication with similarly enabled systems and devices. Subsystem 1340 may further include non-cellular communications such as WiFi or WiMAX.

The embodiments described herein are examples of structures, systems or methods having elements corresponding to elements of the techniques of this application. This written description may enable those skilled in the art to make and use embodiments having alternative elements that likewise correspond to the elements of the techniques of this application. The intended scope of the techniques of this application thus includes other structures, systems or methods that do not differ from the techniques of this application as described herein, and further includes other structures, systems or methods with insubstantial differences from the techniques of this application as described herein.

1. A method at a mobile device for recognizing and adapting to a case for the mobile device, the method comprising:
obtaining a reading from a magnetic sensor on the mobile device associated with a magnet on the case for the mobile device;
determining, from the reading, at least one of a polarity or a magnetic field strength of the magnet;
identifying a type of the case for the mobile device based on the at least one of the polarity or magnetic field strength of the magnet, the case comprising a button in a location that corresponds with a button of the mobile device such that pressing the button of the case presses the button of the mobile device; and
adapting the mobile device to the type of the case for the mobile device, said adapting comprising: providing, based on the type of the case, a display aligned with at least one window of the case; and modifying, based on the type of the case, functionality for the button of the mobile device.

2. (canceled)

3. (canceled)

4. The method of claim 1, wherein the magnetic field strength is enumerated into a plurality of discrete values and wherein the reading assigns the field strength to a closest enumerated discrete value.

5. The method of claim 1, wherein the magnetic sensor is a Hall Effect sensor.

6. The method of claim 1, wherein the identifying uses a table stored on the mobile device.

7. The method of claim 6, wherein the table defines a behavior of the mobile device for the adapting.

8. The method of claim 1, wherein the identifying utilizes a query to a database remote from the mobile device.

9. The method of claim 1, further comprising:
obtaining a reading from a second magnetic sensor on the mobile device;
determining, from the reading, at least one of a polarity or a magnetic field strength of a second magnet corresponding to the second magnetic sensor; and
using the at least one of the polarity or the magnetic field strength of the second magnet for the identifying.

10. The method of claim 1, wherein the magnetic sensor determines both a polarity and magnetic field strength.

11. A mobile device configured for recognizing and adapting to a case for the mobile device, the mobile device comprising:
a processor;
a user interface; and
a magnetic sensor,
wherein the mobile device is configured to:
obtain a reading from a magnetic sensor on the mobile device associated with a magnet on the case for the mobile device;
determine, from the reading, at least one of a polarity or a magnetic field strength of the magnet;
identify a type of the case for the mobile device based on the at least one of the polarity or magnetic field strength of the magnet, the case comprising a button in a location that corresponds with a button of the mobile device such that pressing the button of the case presses the button of the mobile device; and
adapt the mobile device to the type of the case for the mobile device, said adapting comprising: providing, based on the type of the case, a display aligned with at least one window of the case; and modifying, based on the type of the case, functionality for the button of the mobile device.

12. (canceled)

13. (canceled)

14. The mobile device of claim 11, wherein the magnetic field strength is enumerated into a plurality of discrete values and wherein the reading assigns the field strength to a closest enumerated discrete value.

15. The mobile device of claim 11, wherein the magnetic sensor is a Hall Effect sensor.

16. The mobile device of claim 11, wherein the mobile device is configured to identify using a table stored on the mobile device.

17. The mobile device of claim 16, wherein the table defines a behavior of the mobile device for the adapting.

18. The mobile device of claim 11, wherein the mobile device is configured to identify using a query to a database remote from the mobile device.

19. The mobile device of claim 11, further configured to:
obtain a reading from a second magnetic sensor on the mobile device;
determine, from the reading, at least one of a polarity or a magnetic field strength of a second magnet corresponding to the second magnetic sensor; and
use the at least one of the polarity or the magnetic field strength of the second magnet for the identifying.

20. The mobile device of claim 11, wherein the magnetic sensor determines both a polarity and magnetic field strength.

21. A non-transitory computer readable medium for storing instructions which when executed by a processor at a mobile device enable recognizing and adapting the mobile device to a case for the mobile device, the instructions comprising code for:
obtaining a reading from a magnetic sensor on the mobile device associated with a magnet on the case for the mobile device;
determining, from the reading, at least one of a polarity or a magnetic field strength of the magnet;
identifying a type of the case for the mobile device based on the at least one of the polarity or magnetic field strength of the magnet, the case comprising a button in a location that corresponds with a button of the mobile device such that pressing the button of the case presses the button of the mobile device; and
adapting the mobile device to the type of the case for the mobile device, said adapting comprising: providing, based on the type of the case, a display aligned with at least one window of the case; and modifying, based on the type of the case, functionality for the button of the mobile device.

31. (canceled)
